(19) United States
(12) Patent Application Publication
(10) Pub. No.: US 2013/0325722 A1
(43) Pub. Date: Dec. 5, 2013

(54) PAYMENT RECONCILIATION SYSTEM

(71) Applicants: Inder Mohan, San Ramon, CA (US); Prasanna Laxminarayanan, San Ramon, CA (US)

(72) Inventors: Inder Mohan, San Ramon, CA (US); Prasanna Laxminarayanan, San Ramon, CA (US)

(21) Appl. No.: 13/905,045

(22) Filed: May 29, 2013

Related U.S. Application Data
(60) Provisional application No. 61/652,753, filed on May 29, 2012.

(51) Int. Cl. G06Q 20/14

(52) U.S. Cl. CPC G06Q 20/14
USPC 705/44

(57) ABSTRACT

The methods and systems described herein include a data gateway adapted to automate payment reconciliation between a buyer and a supplier of goods and services. The data gateway can be configured to receive and validate payment instructions for one or more payment transactions between the buyer and the supplier to select a payment method based on the payment instructions. Transaction request messages are generated and transmitted to a payment processing network or a payment transfer system associated with the selected payment method. A payment reconciliation message can then be generated and transmitted by the data gateway to a buyer adapter associated with a buyer computer system and a supplier adapter associated with a supplier computer system when the data gateway receives payment authorization from the payment processing network or payment transfer system.

### CROSS-REFERENCES TO RELATED APPLICATIONS

This application claims priority to U.S. Provisional Patent Application No. 61/652,753, filed May 29, 2012, entitled “INTEGRATION APPLICATION,” which is incorporated herein in its entirety.

### FIELD OF THE INVENTION

The embodiments described herein relate generally to integrating payment data processing systems. More particularly, the embodiments relate to an automated system for reconciling payments between buyers and suppliers of goods or services.

### BACKGROUND

Current supplier and buyer transactions are processed through a series of steps in order to ensure that an order can be fulfilled and that a supplier will be paid upon fulfillment. Due to the large amount of product being supplied and the high cost of the product, the transactions is often processed through multiple stages and departments within each company for approval and for reporting. Each order request generated at one company may vary in format from those at another company.

Accordingly, a buyer may order a product from a supplier and the order may be sent to an accounts payable department in the buyer's company in a first format. The order may then be processed by the supplier in a second format and sent to its accounts receivable department. In order to complete the transaction, the supplier may then send a paper or electronic bill to the buyer and the buyer is then responsible for providing payment through a paper check or a pre-approved large credit card payment to the supplier. The buyer can then review the order via the supplier bill and both the buyer and the supplier can settle the transaction within their own respective systems.

The aforementioned process is cumbersome as the transaction involves numerous steps and additional time in order to verify, submit, process, and approve a transaction. Currently, each entity, such as the buyer, supplier, and the payment processor, can have a particular protocol which is followed and a specific format in which the data is processed in their respective systems. These specific formats can be included in an enterprise resource planning (“ERP”) system which can be tailored to each entity in order to facilitate processes within that entity. ERP systems are well known and can be used to integrate internal and external management of information across an organization—encompassing, for example, finance, accounting, manufacturing, sales and service, and customer relationship management business units. ERP systems can automate one or more of the functions of these integrated business units to facilitate information flow among them.

Although the transaction data can easily be submitted, viewed, and processed through a single entity, additional information, such as settlement information from a different entity may need to be manually entered into the entity's ERP system.

Embodiments described herein address these and other problems individually and collectively.

### SUMMARY

The methods and systems described herein include a data gateway adapted to automate payment reconciliation between a buyer and a supplier of goods and services. In at least certain embodiments, the data gateway is configured to receive and validate payment instructions for one or more payment transactions between the buyer and the supplier and to select a payment method based on the payment instructions. In one embodiment, a rules engine and a database coupled with the rules engine are also provided. The database stores rules or parameters to enable the rules engine to select the payment method based on preferences of the buyer and supplier. Transaction request messages can be generated and transmitted to a payment processing network or a payment transfer system associated with the selected payment method.

In one embodiment the buyer computer system is an accounts payable management system and the supplier computer system is an accounts receivable management system. A buyer adapter integrated with the buyer computer system can also be provided to translate messages sent from the buyer to the data gateway into a first standard format and to translate messages received from the data gateway into a format compatible with the buyer computer system. Similarly, a supplier adapter integrated with the supplier computer system can be provided to translate messages sent from the supplier to the data gateway into a second standard format and to translate messages received from the data gateway into a format compatible with the supplier computer system. In one embodiment, the first and second standard format messages can be formatted in the same common standard format.

The payment processing network or payment transfer system can then process the payment according to the payment method selected and provide a transaction response message to the data gateway. A payment reconciliation message can then be generated and transmitted by the data gateway to the buyer adapter and supplier adapter when the gateway receives payment authorization from the payment processing network or payment transfer system.

In yet other embodiments, a system adapted to automate payment reconciliation between a buyer and a supplier of goods and services is provided. The system includes a payment instruction validation unit adapted to validate payment instructions for one or more payment transactions between the buyer and the supplier received from a buyer adapter associated with a buyer computer system. The system also includes a rules engine adapted to select a payment method provided in the payment instructions and a database coupled with the rules engine that is adapted to store rules for selecting the payment method based on preferences of the buyer and supplier. The rules engine can be configured to select the payment method provided in the payment instructions unless the rules for selecting the payment method indicate a different payment method.

The system can also include a network interface to receive the payment instructions from the buyer adapter and to transmit transaction request messages to a payment processing network or a payment transfer system associated with the selected payment method to process the payment transactions. The system also includes a payment reconciliation unit adapted to generate payment reconciliation messages to be transmitted to the buyer adapter and a supplier adapter associated with a supplier computer system via the network interface when it receives payment authorization from the payment processing network or payment transfer system.

In one embodiment, the buyer computer system is an accounts payable management system of the buyer and the supplier computer system is an accounts receivable management system of the supplier. The buyer adapter can be configured to translate messages sent to the network interface of the system into a first standard format and to translate messages received from the network interface into a format compatible with the buyer computer system. The supplier adapter can be configured to translate messages sent to the network interface of the system into a second standard format and to translate messages received from the network interface into a format compatible with the supplier computer system.

In at least certain embodiments, the buyer adapter can be configured to automatically reconcile the buyer accounts payable management system based on an acknowledgement received from a payment acknowledgement unit and the supplier adapter can be configured to automatically update open items in the supplier accounts receivable management system based on remittance advice information received from a payment remittance unit of the data gateway.

### BRIEF DESCRIPTION OF THE DRAWINGS

FIG. 1 depicts an example block diagram of a payment reconciliation system according to one embodiment.

FIG. 2 depicts an example block diagram of a data gateway for a payment reconciliation system according to one illustrative embodiment.

FIG. 3A depicts an example block diagram of a buyer adapter for a payment reconciliation system according to one illustrative embodiment.

FIG. 3B depicts an example block diagram of a supplier adapter for a payment reconciliation system according to one illustrative embodiment.

FIG. 4 depicts an example flow chart for a process of payment reconciliation according to one illustrative embodiment.

FIG. 5 depicts an example flow chart showing further details of the process of payment reconciliation according to one illustrative embodiment.

FIG. 6 illustrates an exemplary computer system which can be utilized in the systems according to embodiments of the invention.

### DETAILED DESCRIPTION

The methods and systems described herein include a data gateway adapted to automate payment reconciliation between a buyer and a supplier of goods and services. In at least certain embodiments, the data gateway is configured to receive and validate payment instructions for one or more payment transactions between the buyer and the supplier and to select a payment method based on the payment instructions. The buyer computer system can be associated with an accounts payable management system of the buyer and the supplier computer system can be associated with an accounts receivable management system of the supplier. In one embodiment, the accounts payable management system of the buyer and the accounts receivable management system of the supplier are ERP systems.

A buyer adapter can be provided to translate messages sent from the buyer to the data gateway into a first standard format and to translate messages received from the data gateway into a format compatible with the buyer computer system. A supplier adapter can also be provided to translate messages sent from the supplier to the data gateway into a second standard format and to translate messages received from the data gateway into a format compatible with the supplier computer system. In one embodiment, the first and second standard format messages can be a same common format. The first and second standard format messages can also be formatted into an electronic data interchange (“EDI”) format. EDI format is well known and refers to a method of transferring data between different computer systems or networks, and is commonly used by companies for ecommerce purposes. Companies can develop automated systems to convert paper or electronic purchase orders from their accounts payable management systems or invoices from their accounts receivable management systems into EDI messages.

In one embodiment, a rules engine and a database coupled with the rules engine are provided within the data gateway. The database can be configured to store rules or parameters (hereinafter “rules”) based on payment preferences of the buyer and supplier to enable the rules engine to select an appropriate payment method based on the stored rules. The rules engine can be configured to select the payment method based on the one provided in the payment instructions unless the rules stored in the database indicate a different payment method based on the preferences of the buyer or supplier. For instance, the rules engine generally selects the payment method provided in the payment instructions unless the rules indicate that the supplier does not accept that particular payment method.

A “payment instruction” can be an instruction to pay a particular supplier a specified amount. The payment could be for a particular good or service that has already been provided by the supplier, or is to be provided to the supplier in the future. A payment instruction may include a supplier name, a purchase amount, and a time or time period in which the payment transaction is to be executed.

A “payment instruction message” can include an electronic communication that contains one or more payment instructions and optionally conditional control data. In some embodiments, there can be more than 5, 10, 15 or 20 payment instructions per payment instruction message. A payment instruction message according to an embodiment of the invention may include multiple payment instructions to a single supplier, or multiple payment instructions to multiple suppliers. The payment instruction message can be in any suitable data format including a proprietary format, an EDI (e.g., EDI 820) format, etc. An EDI message format is an Electronic Data Interchange format, which is a computer-to-computer interchange of strictly formatted messages that represent documents other than monetary instruments. In embodiments of the invention, a payment instruction message is typically transmitted by a buyer device operated by a buyer. Suitable message connectivity options may include SFTP, FTPS, HTTPS, and AS2.

Transaction request messages can then be generated and transmitted to a payment processing network or a payment transfer system associated with the selected payment method. In some embodiments the transaction request message is an “authorization request message” as is known in the art which can be transmitted to the payment processing network or the payment transfer system associated with the selected payment method. An “authorization request message” may include a message requesting that an issuer of an account used by the buyer or supplier to authorize a financial transaction. An authorization request message may comply with ISO 8583, which is a standard format for systems that exchange electronic transactions using payment devices. Authorization request messages may comply with other suitable standards. The authorization request message may include an issuer account identifier that may be associated with a payment device or payment account. An authorization request message may also comprise additional data elements corresponding to identification information including, by way of example only, a service code, a CVV (card verification value), a dCW (dynamic card verification value), an expiration date, etc. An authorization request message may also comprise transaction information such as any information associated with a current transaction, the transaction amount, supplier or merchant identifier, location, etc., as well as any other information that may be utilized in determining whether to authorize a transaction

The payment processing network or the payment transfer system can then process the payment and provide a transaction response message to the data gateway. In one embodiment, the transaction response message can be an “authorization response message.” An authorization response message may be an electronic message in reply to an authorization request message generated by an issuing financial institution or a payment processing network. The authorization response message may include one or more of the following status indicators: Approval—transaction was approved; or Decline—transaction was not approved. The authorization response message may also include an authorization code, which may be a code that a credit card issuing bank returns in response to an authorization request message in an electronic message (either directly or through the payment processing network) to the supplier/merchant that indicates approval of the transaction.

In at least certain embodiments, the buyer adapter can automatically extract payment instructions from the buyer accounts payable management system integrated with the buyer computer system when a payment to the supplier has been approved and can send the extracted instructions to the data gateway in the first standard format. An acknowledgement message can then be sent to the buyer adapter in the format compatible with the buyer computer system when the payment instructions are validated and the buyer adapter can be configured to automatically reconcile buyer accounts payable management systems based on the acknowledgement received from a payment acknowledgement unit in the data gateway. The buyer's “accounts payable management system” as used herein refers to any data processing system adapted to manage an entity's money owed to its suppliers shown as a liability on the entity's balance sheet. An accounts payable can be recorded in a sub-ledger at the time an invoice is vouchered for payment, meaning at the time when the invoice is approved for payment and has been recorded in a “General Ledger” or equivalent of the buyer as an outstanding or open liability until it has not been paid.

A remittance advice information can also be sent to the supplier adapter in the format compatible with the supplier computer system when the payment instructions are validated and the supplier adapter can automatically update open items in the supplier accounts receivable management system based on the remittance advice information received from a payment remittance unit in the data gateway. A “remittance advice” is well known and refers to a communication (either in paper or electronic form) sent by a customer (buyer) to a supplier to inform the supplier that their invoice has been paid. It may include a communication in letter or voucher form. In addition, the supplier's “accounts receivable management system” as used herein refers to any data processing system adapted to manage money owed to an entity by its clients (customers or debtors) and shown on its balance sheet as an asset. It is one of a series of accounting transactions dealing with the billing of a customer for goods or services the customer has ordered. Accounts receivable represents money owed to the entity based on the sale of products or services on credit. In most business entities, accounts receivable is typically executed by generating an invoice and either mailing or electronically delivering it to the customer, who, in turn, must pay it within an established timeframe. The accounts receivable departments use a “sales ledger,” which normally includes a listing of sales made and the amount of money received for goods or services. Accounts receivable is in charge of receiving funds on behalf of an entity and applying it towards their current pending balances.

A payment reconciliation message can then be generated by the data gateway and transmitted to the both buyer and the supplier via their respective adapters when the data gateway receives the payment authorization from the payment processing network or payment transfer system. Embodiments of the techniques disclosed herein are adapted to automate this process between the buyer and supplier.

The embodiments disclosed herein have a number of advantages. For example, embodiments facilitate interactions among entities having different payment systems with different data formats by allowing the data to be converted into a standard format and processed through a single payment channel in an automated payment reconciliation system using a single data gateway. This allows for more efficient remittance and reporting of purchases and sales by processing the transaction through the single data gateway and providing both the buyer and the supplier with messaging in one or more standard formats or a common format. The data gateway works as a central hub to manage data exchange and to ensure proper processes are invoked to make payments using either credit or debit card transactions, automated clearing house (“ACH”) transactions, wire transfers, or other equivalent methods. Embodiments are adapted to automate payment processes and data between buyers and suppliers to provide an end-to-end automated payment reconciliation system.

### I. Exemplary Systems

Provided below is a description of an illustrative system in which embodiments provided herein may be implemented and utilized. Although some of the entities may be depicted as separate components, in some instances one or more of the components may be combined into a single device or location (and vice versa). Similarly, although certain functionality may be described as being performed by a single entity or component within the system, the functionality may, in some instances, be performed by multiple components or entities (and vice versa). Communication between entities and components may comprise the exchange of data or information using electronic messages on any suitable electronic communication medium as described below.

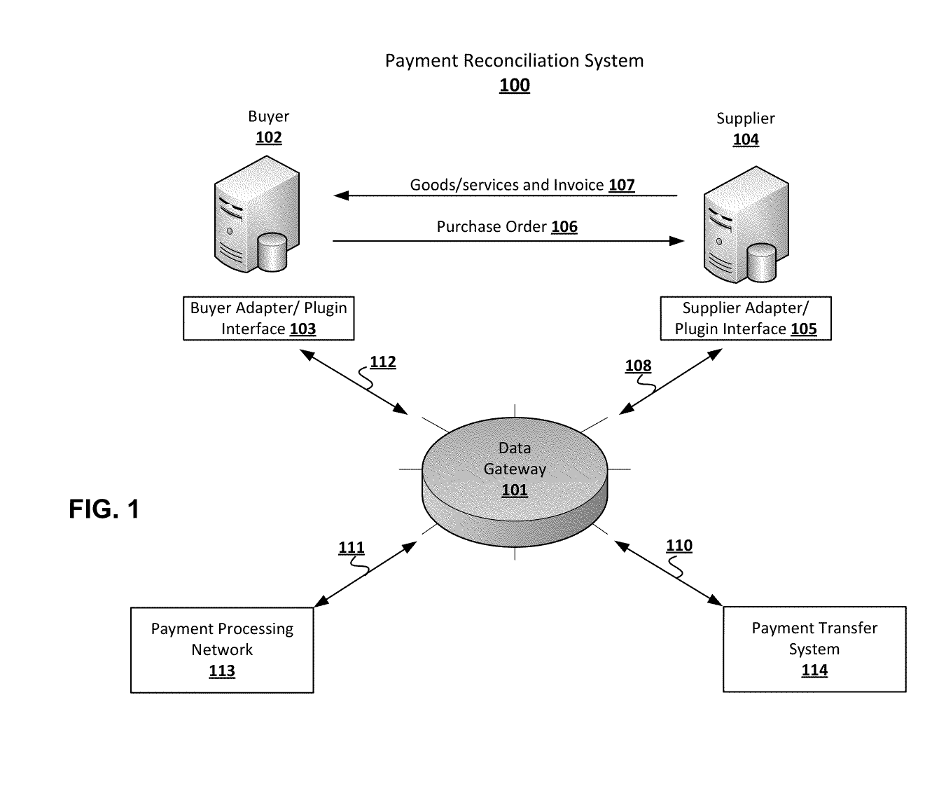

FIG. 1 depicts an example block diagram of a payment reconciliation system according to one embodiment. In the illustrated embodiment, the payment reconcilliation system 100 includes a data gateway 101 that couples together the other elements of the system including buyer computer system 102 via buyer adapter/plugin interface 103 and network connection 112, supplier computer system 104 via supplier adapter/plugin interface 105 and network connectin 108, a payment processing network 113 via network connection 113, and a payment transfer system 114 via network connection 110. The network connections 108-112 are not germane to the techniques described herein and are intended to be interpreted broadly. For instance, these network connections can be any wired or wireless connection such as Internet network connections, local area network (“LAN”) or wide area network (“WAN”) connections, interconnect buses, telecommunication networks, or any other connection whereby data and other information can be exchanged, etc.

The “data gateway” may include a server computer or other device or system adapted to transact data between two or more sources using communication protocols specific to each. In one embodiment, the data gateway is a business-to-business (“B2B”) gateway adapted for commerce transactions between businesses, such as between buyer and supplier companies, manufacturers and wholesalers, or wholesalers and retailers, among others. The data gateway can include a server computer that is capable of performing a data exchange service for various entities such as the supplier, buyer, payment processor, an acquirer or other entities which may utilize the data exchanged therebetween. The gateway can manage the data exchange between the aforementioned entities and can ensure proper payment processes are invoked to make payments utilizing, e.g., credit cards, ACH, wire transfer, or other payment methods. Although the techniques described herein are primarily focused on B2B transactions between for-profit entities, the embodiments are not limited to that as the data gateway may also be a business-to-consumer (“B2C”) and business-to-government (“B2G”); or a gateway between any two entities engaging in a payment reconciliation process.

As used herein, an “issuer” refers to a business entity (e.g., a bank or other financial institution) that maintains financial accounts for its customers and issues a payment device such as a credit or debit card associated with its customers' accounts. A buyer is generally any person or entity that contracts (explicitly or otherwise) to acquire an asset in return for a form of consideration. As used herein the term “buyer” refers to an issuer's participating buyer who submits accounts payable files to the data gateway for processing. A supplier is generally any person or entity that provides the assets to a buyer based on the contract. A supplier may refer to a manufacturer, a packager, a distributor, a wholesaler, a dealership, or any other type of merchant entity that supplies goods or services in exchange for consideration. As used herein a “supplier” refers to a business partner of the buyer whose account payables are due receives payment notifications from the data gateway.

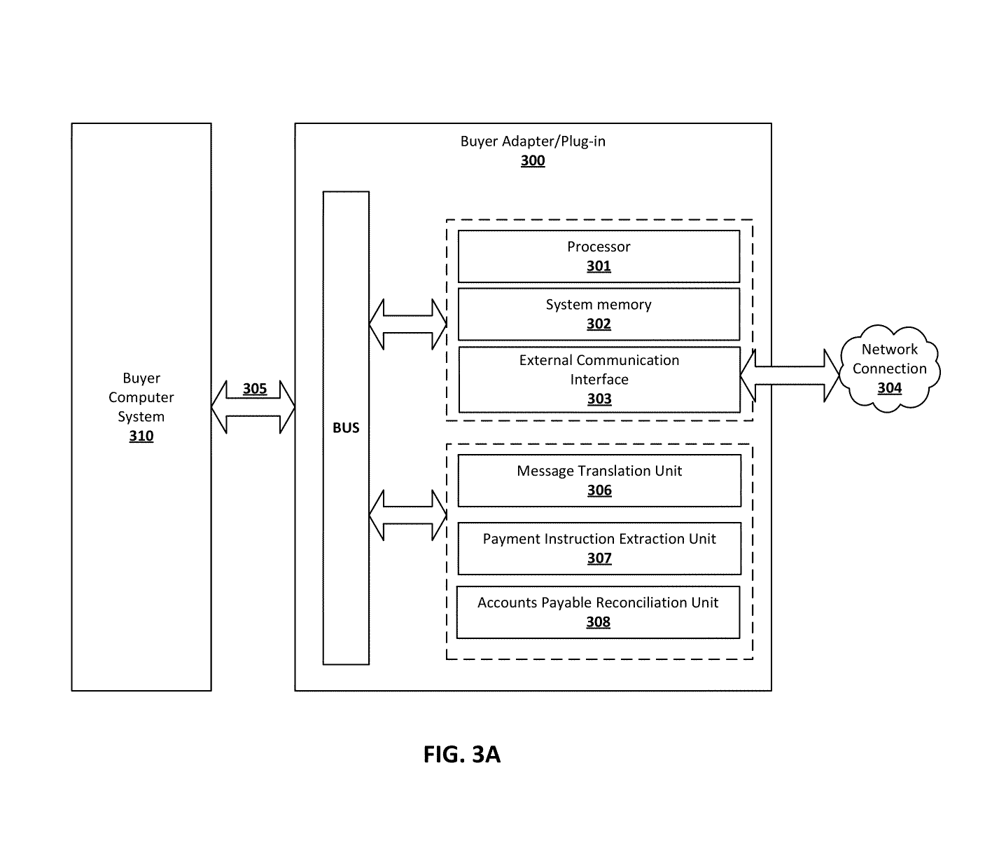

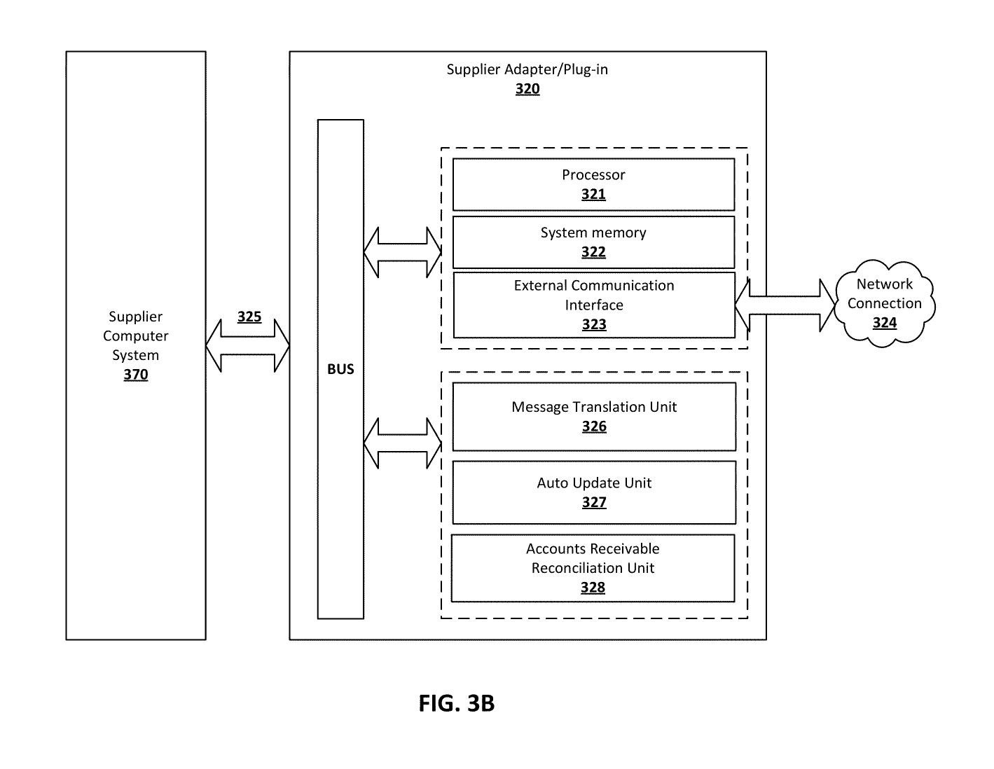

As shown in the block diagram of FIG. 1, buyer computer system 102 can place a purchase order 106 directly into the system and have it communicated to the supplier computer system 104 via the data gateway 101 and supplier adapter/plugin interface 105. The supplier can then provide the goods and services to the buyer as well as provide an invoice 107 corresponding to the purchase order 106 to the buyer via the data gateway 101 and buyer adapter/plugin interface 103. The details of certain embodiments of the buyer and supplier adapter/plugin interfaces are shown and described in FIGS. 3A-3B. The buyer and supplier computer systems are not germane to the techniques described herein and can be any type of data processing system having a processor adapted to execute instructions and a memory adapted to store instructions and data therein. Such data processing systems may include server computers, mainframes, personal computers (“PCs”), notebook or laptop computers, or other mobile computing devices such as hand-held computer systems, smartphones or PDAs, set-top boxes, electronic cash registers, automated teller machines (“ATMs”), virtual cash registers, kiosks, security systems, access systems, etc.

Similarly, the data gateway described herein can be any of these or other types of data processing systems. The data gateway is configured to receive and validate payment instructions for one or more payment transactions between the buyer and the supplier and to select a payment method based on the payment instructions. Transaction request messages can then be generated by the data gateway and transmitted to a payment processing network or a payment transfer system associated with the selected payment method. In some embodiments the transaction request message is an “authorization request message” as is known in the art which can be transmitted to the payment processing network or the payment transfer system associated with the selected payment method.

As used herein a “payment processing network” such as payment processing network 113 refers to a network of suitable processing entities (e.g., computers or servers) that have the ability to route transactions and include information related to accounts of various entities or persons who possess a portable consumer device such as a debit or credit card associated with the account. Payment processing networks may have or operate at least a server computer and may include a database. The database may include any hardware, software, firmware, or combination thereof for storing and facilitating retrieval of information. Also, the database may use any of a variety of data structures, arrangements, or compilations to store and retrieve information. The server computer may be coupled to the database and may include any hardware, software, other logic, or combination thereof and may comprise one or more computational devices and use any of a variety of computing structures, arrangements, or compilations for servicing requests from one or more client computers. The payment processing network may include data processing subsystems, networks, and operations used to support or deliver authorization services, exception file services, or clearing and settlement services. An example of a payment processing network includes VisaNet™ Networks that include VisaNet™ are able to process credit and debit card transactions as well as other types of commercial transactions. VisaNet™, in particular, includes an integrated payments system which processes authorization requests and a Base II system which performs clearing and settlement services. A payment processing network may use any suitable wired or wireless network such as the Internet.

As used herein a “payment transfer system” such as payment transfer system 114 refers to and system capable of performing money transfer. Payment transfer systems generally refer to one of the following cashless modes of payment or payment systems including: wire transfer systems, e.g., expedited bank-to-bank funds transfer, electronic funds transfer, email money transfer, money order, etc. For example, the payment transfer system may be an automated clearing house (“ACH”) wire transfer system. ACH processes large volumes of credit and debit transactions in batches. ACH credit transfers include direct deposit payroll and vendor payments. ACH direct debit transfers include consumer payments on insurance premiums, mortgage loans, and other kinds of bills.

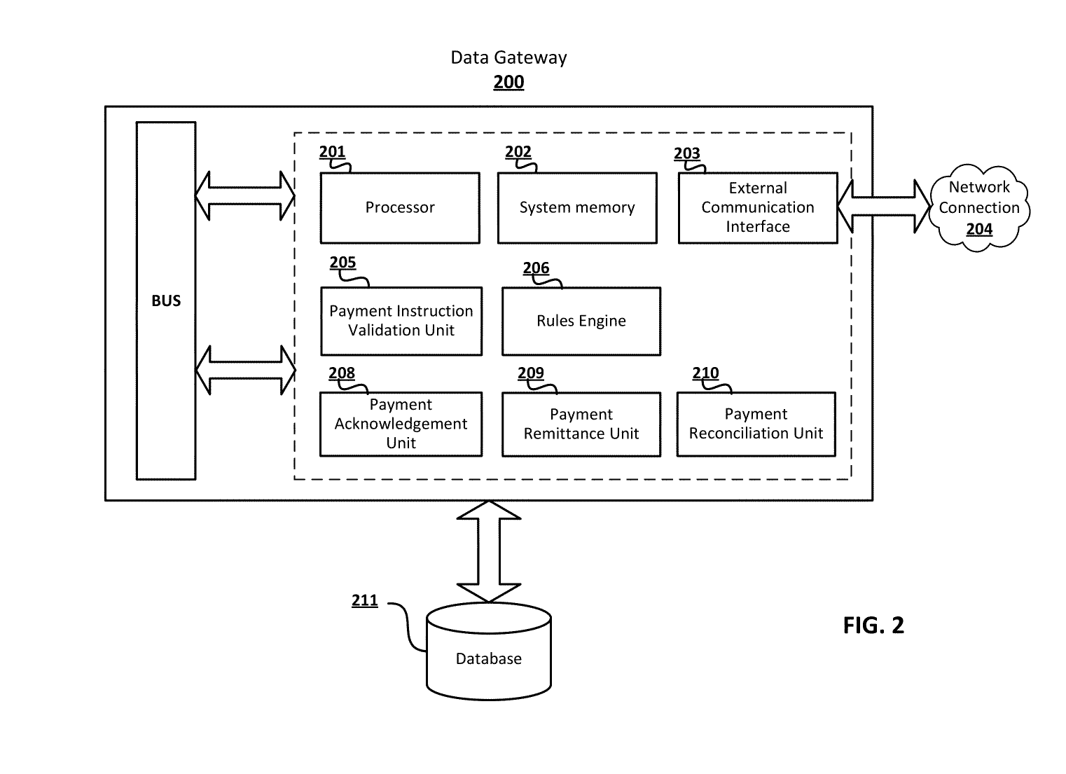

FIG. 2 depicts an example block diagram of a data gateway for a payment reconciliation system according to one illustrative embodiment. In the illustrated embodiment, data gateway 200 includes a plurality of units coupled together via an interconnect bus including a processor 201, system memory 202, and an external communications interface 203 coupled with a network connection 204. Gateway 200 further includes a payment instruction validation unit 205, a rules engine 206, a payment acknowledgement unit 208, a payment remittance unit 209, and a payment reconciliation unit 210. The units within the data gateway 200 can be implemented in hardware, software, firmware, or any combination thereof. In various embodiments, hardwired circuitry may be used independently, or in combination with software instructions, to implement these techniques. For instance, the described functionality may be performed by specific hardware components containing hardwired logic for performing operations or by any combination of hardware components and programmed computer components. The techniques described herein are not limited to any specific combination of hardware circuitry and software.

In other embodiments, the data gateway 200 may comprise a processor, and a computer readable medium coupled to the processor. The computer readable medium includes code executable by the processor for implementing the various techniques described herein. As discussed previously, these techniques include receiving, by the data gateway, payment instructions for one or more payment transactions between a buyer and a supplier of goods or services from a buyer adapter associated with a buyer computer system; validating, by the data gateway, the payment instructions and selecting a payment method based on the payment instructions; transmitting, by the data gateway, a transaction request message corresponding to the selected payment method to a payment processing network or a payment transfer system associated with the selected payment method; and transmitting, by the data gateway, a payment reconciliation message to the buyer adapter and a supplier adapter associated with a supplier computer system when the gateway receives payment authorization from the payment processing network or payment transfer system

In at least certain embodiments, the payment instruction validation unit 205 is adapted to validate payment instructions for one or more payment transactions between a buyer and a supplier received from the buyer computer system. The payment instructions can be received from the buyer computer system by the external communication interface 203 of the data gateway. In one embodiment, the payment instructions can be sent in EDI 820 format. The payment instructions can include the payment method chosen by the buyer that is to be used for one or more transactions with the supplier. The rules engine 206 is configured to receive the payment instructions and to select a payment method for the transaction based on the payment method provided in the payment instructions and preferences of the buyer and supplier stored in database 211 coupled with the rules engine.

The rules engine can then select the payment method provided in the payment instructions unless the rules for selecting the payment method indicate a different payment method is to be used. Specifically, unless the rules indicate that the supplier does not accept the chosen payment method. In such a case, a message can be sent from the data gateway to the buyer compute system requesting new instructions based on a different payment method. The rules engine 206 basically decides whether to route the transaction to a payment processing network or to a payment transfer system. The data gateway can then transmit a transaction request message to the payment processing network or payment transfer system based on the selected payment method (via the external communications interface) to process the payment transactions.

The buyer computer system can receive an acknowledgement message from the payment acknowledgement unit 208 of the data gateway 200 via the buyer adapter/plugin interface (e.g., of FIG. 1) and can automatically reconcile its accounts payable management system based on the acknowledgement message. In addition, the supplier computer system can receive remittance advice information from the payment remittance unit 209 of the data gateway. In one embodiment, the acknowledgment message is an EDI 997 format message and the remittance advice information is sent in a EDI 820 message format. The supplier computer system can then automatically update open items in its supplier accounts receivable management system based on remittance advice information received from a payment remittance unit of the data gateway.

The payment reconciliation unit 210 can then format the payment authorization and associated settlement information to generate a payment reconciliation message to be transmitted to both the buyer computer system via the buyer adapter and the supplier computer system via the supplier adapter when payment authorization is received from the payment processing network or payment transfer system. The payment reconciliation message can then be translated back into the custom formats compatible with the buyer computer system and the supplier computer system. In one embodiment, the buyer and supplier computer systems are ERP systems and the payment reconciliation message is reformatted back into the respective ERP system formats once received at the adapter/plugin interface of the buyer and supplier ERP systems. The buyer computer system can be associated with an accounts payable management system of the buyer and the supplier computer system can be associated with an accounts receivable management system of the supplier. In one embodiment, the accounts payable management system of the buyer and the accounts receivable management system of the supplier are ERP systems.

As used herein the terms “plugin” or “adapter” can include computer hardware or software stored on a computer-readable medium that provides additional functionality. The adapter can be located or stored on a server computer system which also stores applications to which the adapter interfaces. The adapter in present embodiments can allow for data exchange and payment processing during a reconciliation process through integration with existing platforms and a common and central data gateway. FIG. 3A depicts an example block diagram of a buyer adapter for a payment reconciliation system according to one illustrative embodiment. In the illustrated embodiment, the buyer adapter/plugin 300 is coupled with the buyer computer system 310 via connection 305 and can interface with the data gateway over a network connection 304 via the external communications interface 303. As above, the particular type or manner of these connections is not germane to the techniques described herein and is to be interpreted broadly to include any wired or wireless connection. In one embodiment, the buyer computer system is an ERP system.

Further, in the illustrated embodiment, buyer adapter/plugin 300 includes a plurality of components coupled together via an interconnect bus including a processor 301, system memory 302, external communications interface 303, message translation unit 306, payment instruction extraction unit 307, and accounts payable reconciliation unit 308. The message translation unit 306 can translate messages sent from the buyer to the data gateway into a first standard format and can translate messages received from the data gateway into a format compatible with the buyer computer system. In one embodiment, the first and second standard format messages can be the same common format. The first and second standard format messages can also be formatted into EDI format as discussed above.

The payment instruction extraction unit 307 of the buyer adapter 300 can automatically extract payment instructions from the buyer accounts payable management system of the buyer computer system when a payment to the supplier has been approved and can send the extracted instructions to the data gateway in the first standard format. An acknowledgement message can then be sent to the buyer adapter 300 from the data gateway over network connection 304 in the format compatible with the buyer computer system when the payment instructions are validated. Embodiments of the techniques disclosed herein are adapted to automate this process between the buyer and supplier. The accounts payable reconciliation unit 308 can then automatically reconcile the buyer accounts payable management systems based on the acknowledgement received.

FIG. 3B depicts an example block diagram of a supplier adapter for a payment reconciliation system according to one illustrative embodiment. In the illustrated embodiment, the supplier adapter/plugin 320 is coupled with the supplier computer system 370 via connection 325 and can interface with the data gateway over a network connection 324 via the external communications interface 323. As above, the particular type or manner of these connections is not germane to the techniques described herein and is to be interpreted broadly to include any wired or wireless connection. In one embodiment, the supplier computer system is an ERP system.

Further, in the illustrated embodiment, supplier adapter/plugin 320 includes a plurality of components coupled together via an interconnect bus including a processor 321, system memory 322, external communications interface 323, message translation unit 326, auto update unit 327, and accounts receivable reconciliation unit 328. The message translation unit 326 can translate messages sent from the supplier to the data gateway into a second standard format and can translate messages received from the data gateway into a format compatible with the supplier computer system. Additionally, when the payment instructions from the buyer have been validated, a remittance advice information message can be sent to the supplier adapter 320 from the data gateway over network connection 304 in a format compatible with the supplier computer system. The auto update unit 327 can then automatically update open items in the supplier accounts receivable management system of the supplier computer system based on the remittance advice information message received from the data gateway. Embodiments of the techniques disclosed herein are adapted to automate this process between the buyer and supplier. The accounts receivable reconciliation unit 328 can then automatically reconcile the supplier accounts receivable management system based on the remittance advice information.

In addition, in at least certain embodiments, the first and second standard format messages sent from the buyer and supplier adapters respectively can be formatted in the same common format. The first and second standard format messages can also be formatted into EDI standard format as discussed above.

### II. Exemplary Methods

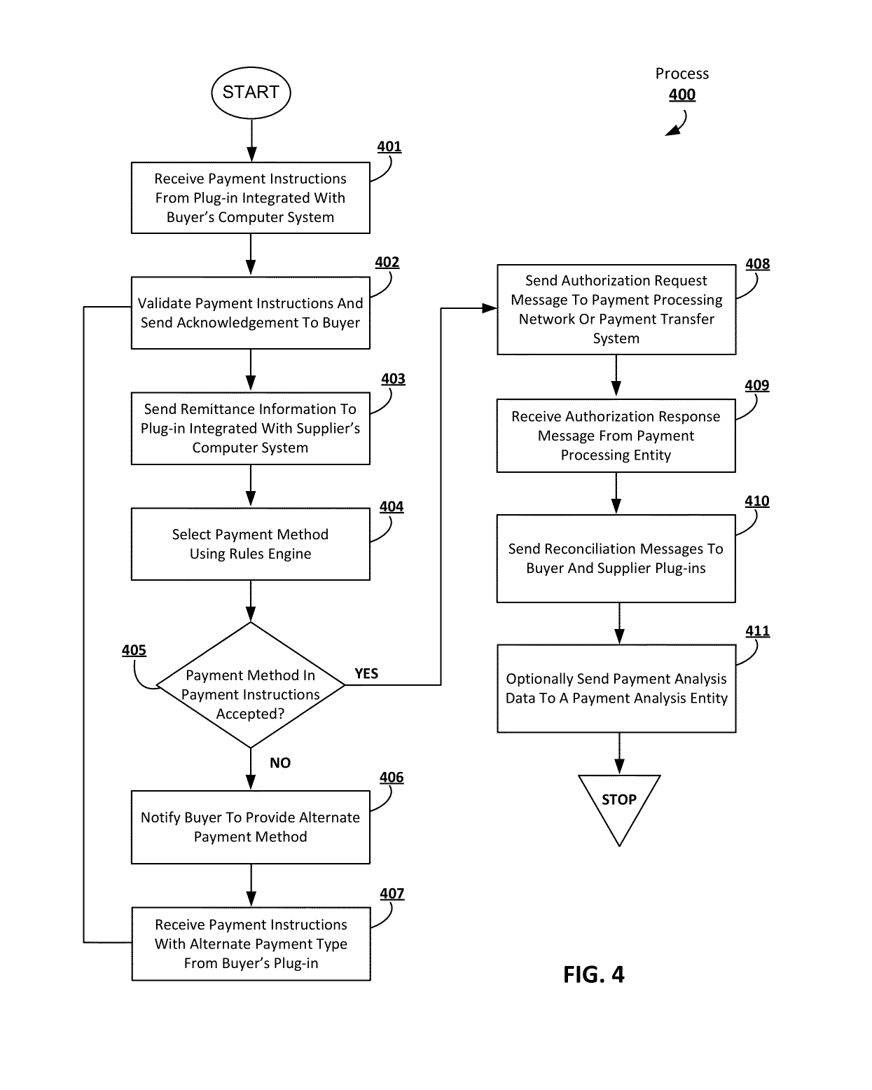

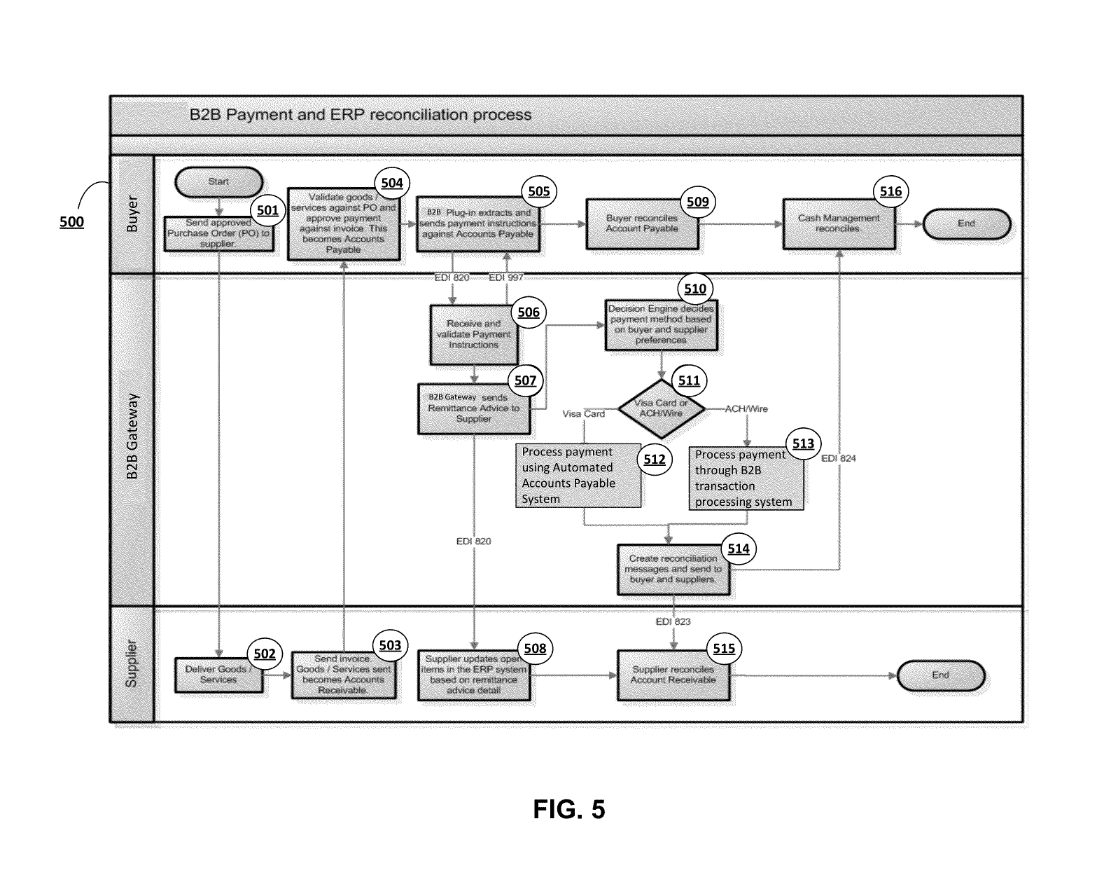

Methods a process of payment reconciliation are described below with reference to FIGS. 4 and 5. The methods described below are exemplary in nature and are provided for illustrative purposes and not intended to be limiting. Methods in accordance with some embodiments described herein may include (or omit) some or all of the operations described below, or may include steps in a different order than described herein. FIG. 4 depicts an example flow chart for a process of payment reconciliation according to one illustrative embodiment. In the illustrated embodiment, process 400 begins at operation 401 where payment instructions are received at the data gateway sent from the buyer adapter/plugin integrated with the buyer computer system. In one embodiment, the buyer computer system is an ERP accounts payable management system and the buyer adapter is operable to automatically extract payment instructions from the buyer accounts payable management system when a payment to the supplier has been approved and to send the payment instructions to the data gateway in the first standard format. The buyer adapter is configured to translate messages sent from the buyer to the data gateway into a first standard format and to translate messages received from the data gateway into a format compatible with the buyer computer system.

Process 400 continues at operation 402 where the payment instructions received from the buyer computer system are validated at the data gateway and an acknowledgment message is sent to the buyer adapter/plugin upon validation. Likewise, a remittance information message is sent to the supplier adapter/plugin integrated with the supplier computer system. In one embodiment, the supplier computer system is an ERP accounts receivable management system. The supplier adapter can also be configured to translate messages sent from the supplier to the data gateway into a second standard format and to translate messages received from the data gateway into a format compatible with the supplier computer system. In one embodiment, the first and second standard format messages are formatted in the same common format.

A rules engine in the data gateway can then select the payment method based on the payment instructions unless payment preferences of the supplier indicate a different payment method is to be provided (operation 404). Then if the payment method is accepted by the supplier in operation 405, an authorization request message corresponding to the selected payment method is transmitted to a payment processing network or a payment transfer system (operation 408). Otherwise, the buyer is notified to provide an alternate payment method (operation 406) and new payment instructions can be received with the alternate payment method from the buyer's plugin (operation 407). Control flows back to operation 402 where the process repeats in the illustrated embodiment.

An authorization response message can then be received by the data gateway from the payment processing network or payment transfer system associated with the selected payment method(operation 409) and reconciliation messages can be generated and transmitted to both the buyer adapter and a supplier adapter (operation 410). Payment analysis data can be optionally transmitted to a payment analysis entity in order to improve the processes described herein (operation 411).

FIG. 5 depicts an example flow chart showing further details of the process of payment reconciliation according to one illustrative embodiment. In the illustrated embodiment, process 500 begins at operation 501 where an approved purchase order is sent from the buyer to the supplier. Process 500 continues at operation 502 where the supplier receives the purchase order and delivers the corresponding goods or services to the buyer. The supplier sends an invoice to the buyer and the goods or services becomes the accounts receivable of the supplier (operation 503). The goods or services are then validated against the purchase order by the buyer and payment is approved against the invoice to become the buyer's accounts payable (operation 504). The buyer plugin then extracts and sends the payment instructions against the accounts payable to the data gateway (operation 505). In the illustrated embodiment, the data gateway is a B2B gateway and the payment instructions are sent using an EDI 820 format message.

The payment instructions are then received and validated by the B2B gateway (operation 506), which sends a remittance advice to the supplier (operation 507). In the illustrated embodiment, the remittance advice is sent to the supplier using an EDI 820 format message. The supplier then updates open items in its ERP system based on the remittance advice detail (operation 508). At operation 510 the decision engine (or rules engine) of the B2B gateway decides on the payment method based on the buyer (and supplier preferences (the buyer preference may be contained within the payment instructions). If the payment is to be made using a credit or debit card transaction (e.g., a Visa card transaction), then control flows to operation 512 where the payment is processed using a payment processing network that has an automated accounts payable system, which may allow for controlled authorizations or straight through processing (as described in U.S. application Ser. No. 13/826,121 filed on Mar. 14, 2013, and 61/680,615, filed on Aug. 7, 2012, the entirety of which is incorporated herein by reference). If the payment is to be made using an ACH or wire payment transfer system, control flows to operation 513 where the payment is so processed (e.g., through a business to business payment transaction processing system). At operation 514, payment reconciliation messages are created and sent to the buyer and suppliers. The supplier can then reconcile its accounts receivable accordingly (operation 515) and the buyer can reconcile its cash management (operation 516). This completes process 500 according to one illustrative embodiment.

### III. Exemplary Data Processing Apparatus

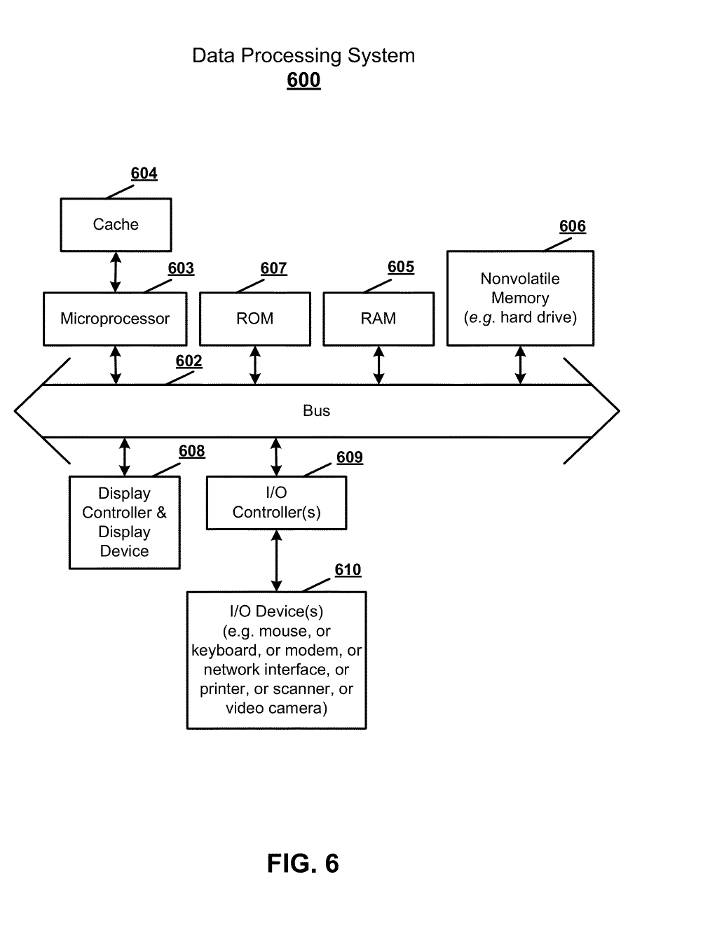

Provided below are descriptions of some devices (and components of those devices) that may be used in the systems and methods described above. These devices may be used, for instance, to receive, transmit, process, or store data related to any of the functionality described above. As will be appreciated by one of ordinary skill in the art, the devices described below may have only some of the components described below, or may have additional components. FIG. 6 depicts an example block diagram of a data processing system upon which the disclosed embodiments may be implemented. Embodiments may be practiced with various computer system configurations such as hand-held devices, microprocessor systems, microprocessor-based or programmable user electronics, minicomputers, mainframe computers, or similar systems. The embodiments can also be practiced in distributed computing environments where tasks are performed by remote processing devices that are linked through a wire-based or wireless network.

FIG. 6 shows one example of a data processing system which may be used with the described embodiments. Note that while FIG. 6 illustrates various components of a data processing system, it is not intended to represent any particular architecture or manner of interconnecting the components as such details are not germane to the techniques described herein. It will also be appreciated that network computers and other data processing systems which have fewer components or perhaps more components may also be used. The data processing system of FIG. 6 may, for example, be a personal computer (PC), workstation, tablet, smartphone or other hand-held wireless device, or any device having similar functionality.

As shown, the data processing system 601 includes a system bus 602 which is coupled to a microprocessor 603, a Read-Only Memory (ROM) 607, a volatile Random Access Memory (RAM) 605, as well as other nonvolatile memory 606. In the illustrated embodiment, microprocessor 603 is coupled to cache memory 604. System bus 602 can be adapted to interconnect these various components together and also interconnect components 603, 607, 605, and 606 to a display controller and display device 608, and to peripheral devices such as input/output (“I/O”) devices 610. Types of I/O devices can include keyboards, modems, network interfaces, printers, scanners, video cameras, or other devices well known in the art. Typically, I/O devices 610 are coupled to the system bus 602 through I/O controllers 609. In one embodiment the I/O controller 609 includes a Universal Serial Bus (“USB”) adapter for controlling USB peripherals or other type of bus adapter.

RAM 605 can be implemented as dynamic RAM (“DRAM”) which requires power continually in order to refresh or maintain the data in the memory. The other nonvolatile memory 606 can be a magnetic hard drive, magnetic optical drive, optical drive, DVD RAM, or other type of memory system that maintains data after power is removed from the system. While FIG. 6 shows that nonvolatile memory 606 as a local device coupled with the rest of the components in the data processing system, it will be appreciated by skilled artisans that the described techniques may use a nonvolatile memory remote from the system, such as a network storage device coupled with the data processing system through a network interface such as a modem or Ethernet interface (not shown).

Embodiments may also be in the form of computer code stored on a computer-readable medium. Computer-readable media can also be adapted to store computer instructions, which when executed by a computer or other data processing system, such as data processing system 600, are adapted to cause the system to perform operations according to the techniques described herein. Computer-readable media can include any mechanism that stores information in a form accessible by a data processing device such as a computer, network device, tablet, smartphone, or any device having similar functionality. Examples of computer-readable media include any type of tangible article of manufacture capable of storing information thereon such as a hard drive, floppy disk, DVD, CD-ROM, magnetic-optical disk, ROM, RAM, EPROM, EEPROM, flash memory and equivalents thereto, a magnetic or optical card, or any type of media suitable for storing electronic data. Computer-readable media can also be distributed over a network-coupled computer system, which can be stored or executed in a distributed fashion.

With these embodiments in mind, it will be apparent from this description that aspects of the described techniques may be embodied, at least in part, in software, hardware, firmware, or any combination thereof. It should also be understood that embodiments can employ various computer-implemented functions involving data stored in a data processing system. That is, the techniques may be carried out in a computer or other data processing system in response executing sequences of instructions stored in memory. In various embodiments, hardwired circuitry may be used independently, or in combination with software instructions, to implement these techniques. For instance, the described functionality may be performed by specific hardware components containing hardwired logic for performing operations, or by any combination of custom hardware components and programmed computer components. The techniques described herein are not limited to any specific combination of hardware circuitry and software.

Throughout the foregoing description, for the purposes of explanation, numerous specific details were set forth in order to provide a thorough understanding of the invention. It will be apparent, however, to persons skilled in the art that these embodiments may be practiced without some of these specific details. Accordingly, the scope and spirit of the invention should be judged in terms of the claims which follow as well as the legal equivalents thereof.

What is claimed is:

1. A method comprising:
receiving, by a data gateway, payment instructions for one or more payment transactions between a buyer and a supplier of goods or services from a buyer adapter associated with a buyer computer system;
validating, by the data gateway, the payment instructions and selecting a payment method based on the payment instructions;
transmitting, by the data gateway, a transaction request message corresponding to the selected payment method to a payment processing network or a payment transfer system associated with the selected payment method; and
transmitting, by the data gateway, a payment reconciliation message to the buyer adapter and a supplier adapter associated with a supplier computer system when the gateway receives payment authorization from the payment processing network or payment transfer system.

2. The method of claim 1 wherein the buyer computer system is an accounts payable management system of the buyer and the supplier computer system is an accounts receivable management system of the supplier.

3. The method of claim 1 wherein the transaction request message is an authorization request message, and wherein the authorization request message is transmitted to the payment processing network or the payment transfer system.

4. The method of claim 1 wherein the data gateway is adapted to automate payment reconciliation between the buyer and the supplier.

5. The method of claim 1 wherein the buyer adapter is configured to translate messages sent from the buyer to the data gateway into a first standard format and to translate messages received from the data gateway into a format compatible with the buyer computer system, and wherein the supplier adapter is configured to translate messages sent from the supplier to the data gateway into a second standard format and to translate messages received from the data gateway into a format compatible with the supplier computer system.

6. The method of claim 2 wherein the buyer adapter is operable to automatically extract payment instructions from the buyer accounts payable management system when a payment to the supplier has been approved and to send the payment instructions to the data gateway in the first standard format.

7. The method of claim 1 further comprising:
sending an acknowledgement message to the buyer adapter in the format compatible with the buyer computer system when the payment instructions are validated; and
sending remittance advice information to the supplier adapter in the format compatible with the supplier computer system when the payment instructions are validated.

8. The method of claim 1 wherein the data gateway is configured to select the payment method provided in the payment instructions unless a rules engine in the data gateway indicates the supplier does not accept the payment method.

9. The method of claim 1 wherein the first and second standard format messages are a same common format.

10. A system comprising:
a payment instruction validation unit adapted to validate payment instructions for one or more payment transactions between a buyer and a supplier of goods or services received from a buyer adapter associated with a buyer computer system;
a rules engine adapted to select a payment method provided in the payment instructions;
a network interface adapted to receive the payment instructions from the buyer adapter and transmit a transaction request message to a payment processing network or a payment transfer system associated with the selected payment method to process the payment transactions; and
a payment reconciliation unit adapted to generate a payment reconciliation message to be transmitted to the buyer adapter and a supplier adapter associated with a supplier computer system via the network interface when the network interface receives payment authorization from the payment processing network or payment transfer system associated with the selected payment method.

11. The system of claim 10 wherein the buyer computer system is an accounts payable management system of the buyer and the supplier computer system is an accounts receivable management system of the supplier.

12. The system of claim 10 further comprising a database coupled with the rules engine and adapted to store rules for selecting the payment method based on preferences of the buyer and supplier.

13. The system of claim 10 wherein the buyer adapter is configured to translate messages sent from the buyer to the network interface into a first standard format and to translate messages received from the network interface into a format compatible with the buyer computer system, and wherein the supplier adapter is configured to translate messages sent from the supplier to the network interface into a second standard format and to translate messages received from the network interface into a format compatible with the supplier computer system.

14. The system of claim 11 wherein the buyer adapter is operable to automatically extract payment instructions from the buyer accounts payable management system when a payment to the supplier has been approved and to send the payment instructions to the network interface.

15. The system of claim 10 further comprising:
a payment acknowledgement unit configured to send an acknowledgement message to the buyer adapter via the network interface when the payment instructions have been validated; and
a payment remittance unit configured to send remittance advice information to the supplier adapter via the network interface when the payment instructions have been validated.

16. The system of claim 10 wherein the rules engine selects the payment method provided in the payment instructions unless the rules for selecting the payment method indicate a different payment method.

17. The system of claim 11 wherein the buyer adapter is configured to automatically reconcile the buyer accounts payable management system based on the acknowledgement received from the payment acknowledgement unit.

18. The system of claim 11 wherein the supplier adapter is configured to automatically update open items in the supplier accounts receivable management system based on the remittance advice information received from the payment remittance unit.

19. A data gateway comprising a processor and a computer readable medium coupled with the processor, the computer readable medium comprising instructions executable by the processor for implementing operations comprising:
receiving, by the data gateway, payment instructions for one or more payment transactions between a buyer and a supplier of goods or services from a buyer adapter associated with a buyer computer system;
validating, by the data gateway, the payment instructions and selecting a payment method based on the payment instructions;
transmitting, by the data gateway, a transaction request message corresponding to the selected payment method to a payment processing network or a payment transfer system associated with the selected payment method; and
transmitting, by the data gateway, a payment reconciliation message to the buyer adapter and a supplier adapter associated with a supplier computer system when the gateway receives payment authorization from the payment processing network or payment transfer system.
